(19) United States
(12) Patent Application Publication
(10) Pub. No.: US 2006/0143473 A1
(43) Pub. Date: Jun. 29, 2006

(54) Software key implementation using system management firmware

(76) Inventor: Mohan J. Kumar, Aloha, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,305

(22) Filed: Dec. 29, 2004

(51) Int. Cl. G06F 12/14

(52) U.S. Cl. 713/189

(57) ABSTRACT

In some embodiments system management firmware of a computing platform is to receive a software key, determine if the software key is valid, and enable a system management feature of the computing platform if the software key is valid. Other embodiments are described and claimed.

### TECHNICAL FIELD

The inventions generally relate to a software key implementation using system management firmware.

### BACKGROUND

Existing schemes for providing value added features (including but not limited to system management features) to a computing system requires hardware SKUs. A SKU is a stock keeping unit that is a number associated with a particular product and used, for example, to track inventory. For example, system management value add is sold via Remote Management Cards. This results in added SKU development cost, and support and inventory management burden.

Some software products are now sold with a software license key (or software key). The software key locks the software program to a single user, for example. In this manner, no physical shipment of software is required while ensuring that the software is not copied and proliferated for use by additional users. A license key can be sent via email to a user in order to upgrade a free trial to a licensed version of the software, for example. When a user purchases software an unlock code can be sent via email to the user. The unlock code can then be used to activate the software. Many software products use software keys. However, the security of such prior software keys is not tied to the target platform, causing a potential for abuse of the key. Hence, such existing schemes cannot be directly adopted for enabling for software key controlled features on a platform.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a software key implementation according to some embodiments of the inventions.

### DETAILED DESCRIPTION

Some embodiments of the inventions relate to a software key implementation using system management firmware.

In some embodiments a software key is received at a system management interface of a platform, a determination is made as to whether the software key is valid, and if the software key is valid a system management feature of the platform is enabled.

In some embodiments system management firmware of a computing platform is to receive a software key, determine if the software key is valid, and enable a system management feature of the computing platform if the software key is valid.

In some embodiments a software scheme allows activation and/or deactivation of software features as well as hardware features without requiring additional hardware, firmware, or software updates (for example, in server products). The hardware and/or software features controlled by software keys (also referred to as a Product Activation Key) are shipped in a disabled state. A customer can enable such features by purchasing a software key that activates the feature.

In some embodiments software keys may be implemented on the platform using a system management interface. The system management interface can be used to control both system management features on the platform (for example, Remote Keyboard Video Mouse Redirection, embedded web server, etc.) as well as platform level features. For example, a component on the platform can implement its own software key scheme by requiring system management to act as the access interface.

In some embodiments implementing software key based enabling on the platform includes software key verification support in system management firmware, installation of software keys to enable the feature, checking the key trace before enabling the feature, support for time trial keys, support for floating installation software key (that is, the key is not node locked until installation), support for floating usage key (this limits the number of active users/sessions at any given time), and/or support for key revocation.

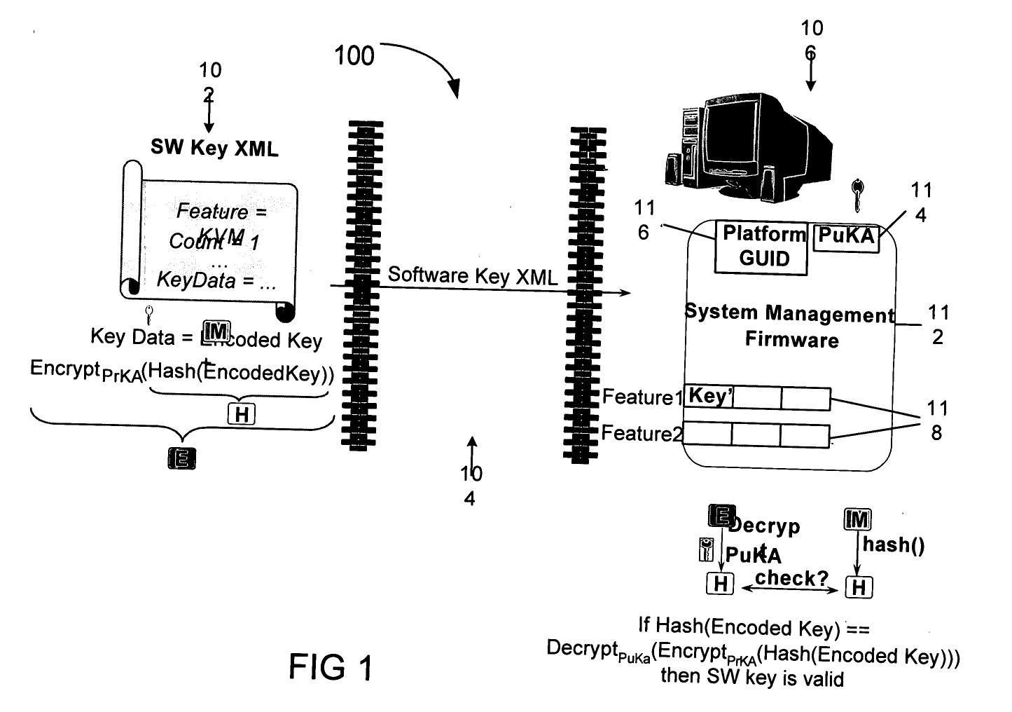

FIG. 1 illustrates using one or more software keys to enable system management features according to some embodiments. Implementation 100 includes a graphical representation of software key encoding 102, software key transmission 104, and a computing platform 106 that determines if the software key is valid. In some embodiments computing platform 106 is a personal computer, a server, a blade, a Storage Area Network (SAN), and/or some other type of computing platform. In some embodiments features that may be enabled using software keys on the platform 106 include, for example, system management features that are value added features such as embedded Web Server, integrated remote KVM (Keyboard, Video, Mouse) redirection support, self-healing support, etc. These features may be integrated in the platform in hardware and/or firmware, but are kept disabled by default and can be enabled subsequently using software keys. These features can also be platform components that implement software keys but require a trusted interface (for example, a system management interface) to install and/or interact with the component software key mechanism.

At 102 a software key is encoded and/or key data is calculated. The encoded software key in some embodments contains information regarding the features enabled by the key, the quantity enabled by the key per feature (for example, a blade server may have enabled remote KVM redirection for 10 blades in the server), timestamp and if it is a trial key, the associated trial period. The software key may be transmitted from 102 to platform 106 via transmission line 104 using Extensive Markup Language (XML) which is often used for Web documents, or using any other technique. Key data is determined using a private key PrKa at 102 as:
Key data=Encoded Key+Encrypt_{PrKa}(Hash(Encoded Key))

The encoded key is shown as “M” in FIG. 1.

The (Hash(Encoded Key)) is shown as “H” in FIG. 1.

The Encrypt_{PrKa} (Hash(Encoded Key)) is shown as “E” in FIG. 1.

Decoding is performed at the platform 106 using a public key PuKa (the public key PuKa corresponds to private key PrKa in a public-key crypto system) and checked as per the Hash(Encoded Key) being the same as the Decrypt_{PuKA} (E). If the results are the same then the software key is determined to be valid.

In some embodiments software key installation and/or verification support is performed in system management (SM) firmware 112 of the platform 106. System management 112 of the target platform 106 includes a decryption key (private key) 114 (identified as “PuKA” in FIG. 1) that enables installation and/or verification of software keys. The system management firmware 112 also includes platform unique information 116 that is used to verify that the software key is intended for the target platform 106. The platform unique information 116 can be any unique identifier of the platform 106 and/or any portion of the platform 106. For example, such platform unique identifier could be a platform Globally Unique Identifer (or Platform GUID), a chassis GUID, a blade GUID, a blade chassis GUID, a server platform GUID, a desktop platform GUID, a chassis backplane GUID, a chassis backplane GUID of a storage area network module, etc. After verifying a match for platform unique information 116, in some embodiments system management firmware 112 verifies the hash of the key information by decrypting the secure block E, defined as Encrypt_{PrKa} (Hash(Encoded Key)) in FIG. 1. If the hashes match as illustrated in FIG. 1 then the software key is valid.

Some embodiments have been described above as using an asymmetric key implementation such as a public key and a private key (for example, in a public-key crypto system). However, other embodiments do not require using a public key and a private key. For example, in some embodiments any other security scheme could be used.

Since system management firmware 112 supports revocation of an installed software key, it is important to prevent reinstallation of a revoked key. For this purpose, system management firmware 112 maintains a key history buffer 118 for each software key enabled feature. In some embodiments key history buffer 118 (and the key history buffer 118 for each feature) includes installation and/or de-installation data relating to the software key. Key history buffer 118 (and the key history buffer 118 for each feature) is illustrated in FIG. 1 as having a three key history, but may have a history of any number of keys according to some embodiments. Further, key history buffer 118 is illustrated in FIG. 1 as having a key history for two different features, but may have a key history for any number of features according to some embodiments. In some embodiments key history buffer 118 (and each individual key history buffer 118 for each feature) may be a dynamic buffer that can dynamically adjust its buffer size. A de-installed software key is marked as such in the key history buffer 118. Upon a new software key installation for a feature, the system management firmware 112 checks against the entries in the key history buffer 118 to verify that it does not match a revoked key for the platform 106 before proceeding with the installation process. In some embodiments once a key history buffer 118 for a particular feature is full, then a user is no longer allowed to de-install (uninstall) the software key associated with that feature. That is, once the buffer is full any requests to revoke a software key are rejected (they are not allowed) to protect against reuse of a revoked key. In addition, some embodiments could be implemented with no key history buffer or counter, for example in lieu of a key history buffer. In some embodiments a non-decrementing counter (monotonic counter) could be used in conjunction with the platform globally unique identifier in the key generation thus preventing the reuse of a revoked key.

In some embodiments for system management value added features that are enabled through software keys, the system management firmware 112 verifies the presence of a valid key each time the feature is invoked. This is due to the allowance of the system management firmware 112 allowing revocation of the software key. In some embodiments the system management firmware 112 supports revocation of a software key by generating an encrypted revocation log (for example, the hash of the revocation acknowledgement is encrypted using the public key 114 PuKA in FIG. 1). The encrypted revocation log provides a reasonable assurance to the key issuer that the software key was indeed revoked. In some embodiments the system management firmware 112 also supports trial keys (which are either time limited or usage limited), keeps track of the expiring of such keys, and prevents reuse of trial keys on a platform for the same feature.

As discussed above existing schemes for providing value add features (including but not limited to system management features) to a computing system requires hardware SKUs. A SKU is a stock keeping unit that is a number associated with a particular product and used, for example, to track inventory. For example, system management value add is sold via Remote Management Cards. This results in added SKU development cost, and support and inventory management burden.

In some embodiments by using a system management interface to implement software keys, a secure and always available interface in the platform can be taken advantage of to implement software key infrastructure. The secure platform interface prevents tampering of the platform unique information, the software key protected features, the installed public key, for example. Additionally, implementing software keys via system management enables the selling of system management value-added features using software keys. Further, in some embodiments, platform designers and/or silicon designers can integrate the hardware required for value-added features into the platform while retaining ability for an “up sell” opportunity relating to the value added features. In some embodiments server platforms and/or blade platforms, for example, can enable value-added system management features using software keys. In some embodiments capacity can be sold on demand features and/or third party enabled features using software keys by enabling them through system management. By selling value-added features through software keys use of expensive hardware SKUs and/or value-added hardware modules may be avoided according to some embodiments. Although the cost of integrating the hardware for the value-added feature could be absorbed by the platform, the feature cost is more than the hardware cost. For example, the feature may involve licensing fees. Using a system management based software key implementation allows a reliable mechanism to be provided to manage software SKUs.

In some embodiments a software key mechanism is implemented using system management firmware. In some embodiments tracking of installation, tracking of de-installation, and tracking of potential misuse and/or abuse of the software key is enabled.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
receiving a software key at a system management interface of a platform;
determining if the software key is valid; and
enabling a system management feature of the platform if the software key is valid.

2. The method of claim 1, wherein the system management feature is at least one of a system management hardware feature or a system management software feature.

3. The method of claim 1, wherein the system management feature is a value added feature of the platform.

4. The method of claim 1, further comprising tracking at least one of a software key installation, a software key de-installation, or a potential misuse of the software key.

5. The method of claim 1, further comprising determining if the software key is intended for the platform in response to a globally unique identifier of the platform.

6. The method of claim 1, further comprising preventing reuse of a software key that has been revoked.

7. The method of claim 1, wherein a public key and a private key are used in determining if the software key is valid.

8. The method of claim 1, further comprising storing at least one of installation or de-installation data relating to the software key.

9. The method of claim 1, further comprising:
storing in a key history buffer at least one of installation or de-installation data relating to the software key; and
once the key history buffer has become full, rejecting requests to revoke the software key.

10. The method of claim 1, further comprising determining an expiration of at least one trial key, and preventing reuse of the at least one trial key on the platform for the same feature.

11. The method of claim 1, further comprising determining an expiration of at least one trial key, and preventing reuse of the at least one trial key on the platform.

12. The method of claim 11, wherein the at least one trial key is at least one of time limited or usage limited.

13. The method of claim 1, wherein the software key includes information relating to at least one of features enabled by the software key, a quantity enabled by the software key per feature, a timestamp, or a trial period of the software key.

14. An article comprising:
a computer readable medium having instructions thereon which when executed cause a computer to:
receive a software key at a system management interface of a platform;
determine if the software key is valid; and
enable a system management feature of the platform if the software key is valid.

15. The article of claim 14, wherein the system management feature is at least one of a system management hardware feature or a system management software feature.

16. The article of claim 14, wherein the system management feature is a value added feature of the platform.

17. The article of claim 14, the computer readable medium further having instructions thereon which when executed cause a computer to track at least one of a software key installation, a software key de-installation, or a potential misuse of the software key.

18. The article of claim 14, the computer readable medium further having instructions thereon which when executed cause a computer to determine if the software key is intended for the platform in response to a globally unique identifier of the platform.

19. The article of claim 14, the computer readable medium further having instructions thereon which when executed cause a computer to prevent reuse of a software key that has been revoked.

20. The article of claim 14, wherein a public key and a private key are used in determining if the software key is valid.

21. The article of claim 14, the computer readable medium further having instructions thereon which when executed cause a computer to store at least one of installation or de-installation data relating to the software key.

22. The article of claim 14, the computer readable medium further having instructions thereon which when executed cause a computer to:
store in a key history buffer at least one of installation or de-installation data relating to the software key; and
once the key history buffer has become full, reject requests to revoke the software key.

23. The article of claim 14, the computer readable medium further having instructions thereon which when executed cause a computer to:
determine an expiration of at least one trial key; and
prevent reuse of the at least one trial key on the platform for the same feature.

24. The article of claim 14, the computer readable medium further having instructions thereon which when executed cause a computer to:
determine an expiration of at least one trial key; and
prevent reuse of the at least one trial key on the platform.

25. The article of claim 24, wherein the at least one trial key is at least one of time limited or usage limited.

26. The article of claim 14, wherein the software key includes information relating to at least one of features enabled by the software key, a quantity enabled by the software key per feature, a timestamp, or a trial period of the software key.

27. An apparatus comprising:
a computing platform including system management firmware;
wherein the system management firmware is to receive a software key, to determine if the software key is valid, and to enable a system management feature of the computing platform if the software key is valid.

28. The apparatus of claim 27, wherein the system management feature is at least one of a system management hardware feature or a system management software feature.

29. The apparatus of claim 27, wherein the system management feature is a value added feature of the computing platform.

30. The apparatus of claim 27, wherein the system management firmware is to track at least one of a software key installation, a software key de-installation, or a potential misuse of the software key.

31. The apparatus of claim 27, wherein the system management firmware is to determine if the software key is intended for the computing platform in response to a globally unique identifier of the platform.

32. The apparatus of claim 27, wherein the system management firmware is to prevent reuse of a software key that has been revoked.

33. The apparatus of claim 27, wherein the system management firmware is to use a public key and a private key to determine if the software key is valid.

34. The apparatus of claim 27, wherein the computing platform further includes a key history buffer to store at least one of installation or de-installation data relating to the software key.

35. The apparatus of claim 34, wherein the system management firmware is to reject requests to revoke the software key once the key history buffer has become full.

36. The apparatus of claim 27, wherein the system management firmware is to determine an expiration of at least one trial key, and to prevent reuse of the at least one trial key on the platform for the same feature.

37. The apparatus of claim 27, wherein the system management firmware is to determine an expiration of at least one trial key, and to prevent reuse of the at least one trial key on the platform.

38. The apparatus of claim 37, wherein the at least one trial key is at least one of time limited or usage limited.

39. The apparatus of claim 27, wherein the computing platform is at least one of a server, a blade, a Storage Area Network or a desktop computer.

40. The apparatus of claim 27, wherein the software key includes information relating to at least one of features enabled by the software key, a quantity enabled by the software key per feature, a timestamp, or a trial period of the software key.
